(19) United States
(12) Patent Application Publication
(10) Pub. No.: US 2012/0018053 A1
(43) Pub. Date: Jan. 26, 2012

(54) COMPOSITION FOR CHEMICAL CONVERSION TREATMENT, AND PROCESS FOR PRODUCING A MEMBER HAVING AN ANTICORROSIVE FILM FORMED FROM THE COMPOSITION

(75) Inventors: Yasuhiro Nagaya, Aichi (JP); Tomoko Ishikawa, Aichi (JP)

(73) Assignee: YUKEN INDUSTRY CO., LTD., Aichi (JP)

(21) Appl. No.: 13/131,282

(22) PCT Filed: Dec. 2, 2009
(86) PCT No.: PCT/JP2009/070248

§ 371 Date: Aug. 8, 2011

(30) Foreign Application Priority Data
Dec. 5, 2008 (JP) 2008-311129

(51) Int. Cl. C23C 22/48; B32B 15/00; C09D 5/08

(52) U.S. Cl. 148/247; 106/14.45; 148/400

(57) ABSTRACT

As an acidic liquid composition capable of forming an anticorrosive film having an appearance and corrosion resistance comparable to the anticorrosive film formed by chromate treatment on a substrate which has a metallic surface and a complicated shape, a chromium-free acidic liquid composition for reactive chemical conversion treatment for use in forming an anticorrosive film on a metallic surface is provided, the composition comprising: at least one oxidative substance selected from a nitric ion and hydrogen peroxide; at least one carboxylic acid compound selected from the group consisting of carboxylic acids, carboxylate ions, carboxylates, and derivatives of carboxylic acids; an aluminum-containing substance; a zirconium-containing substance; and a sulfate ion, wherein the composition does not substantially contain an organic film-forming component. The composition may further contain a water-soluble metal-containing substance as a film-forming component, the water-soluble metal-containing substance containing one or more elements selected from the group consisting of V, Fe, Cu, Sn, Mo, W, Ce, Co, Ni, Mg, Ca, Mn, and Li.

### TECHNICAL FIELD

The present invention relates to a composition for reactive chemical conversion treatment for use in forming an anticorrosive film on the surface of a substrate having a metallic surface such as a zinc plating or a zinc alloy plating, which is generically referred to as a zinc-containing plating.

The present invention also relates to a process for producing a member having an anticorrosive film on the surface of a substrate of the member by using the composition, and a liquid composition for producing the composition.

According to the present invention, an anticorrosive film having a beautiful appearance and a high corrosion resistance can be obtained on a metallic surface of a member such as a member having a zinc-containing plating, which is referred to as a galvanized member, by reactive chemical conversion treatment which is completely chromium free and which can be performed while maintaining a good work environment.

### BACKGROUND ART

Although a galvanized member has high corrosion resistance due to an anticorrosive function in which a zinc-containing plating located on the surface of the member provides a sacrifice action, a white rust is easily formed on the surface of the member.

Therefore, when the galvanized member is used without any painted layer, the member is often subjected to further anticorrosive treatment.

Conventionally, chemical conversion treatment using a chromium compound such as chromate treatment has been performed as anticorrosive treatment for a galvanized member. Chromate treatment can provide high corrosion resistance to a galvanized member. Additionally, chromate treatment can provide the galvanized member with a beautiful appearance such as a black, a yellow, or a silvery interference color. There are different type of the chromate treatment such as coating-type treatment, reactive treatment, and electrolytic treatment. Generally, a solution for coating-type treatment is employed for a steel plate because it can easily form a uniform coating, while a solution for reactive treatment or electrolytic treatment is employed for a fabricated member because it is difficult to uniformly coat such a member employing a solution for coating-type treatment.

However, in view of the hazardousness of hexavalent chromium and environmental regulations, the use of hexavalent chromium is now restricted. Furthermore, a perfect chromium-free chemical conversion treatment has been demanded which contains no hexavalent chromium as well as no trivalent chromium.

Thousands of proposals regarding such a chromium-free chemical conversion treatment containing no hexavalent chromium or trivalent chromium have been presented. However, most of them can be categorized as coating-type treatment for a galvanized steal plate, in which a steel plate after chemical conversion treatment is directly dried without washing the treated plate.

Patent Document 1 discloses, as such a coating-type chromium free chemical conversion treatment, a method for forming a protective film on a metallic member, the method comprising a step of coating the surface of the member with a layer chemically formed from an acidic aqueous liquid composition, and a step in which the layer is dried without rinsing the member, wherein the acidic aqueous liquid composition comprises (A) at least one substance selected from the group consisting of trivalent chromium, Ti, V, Mn, Y, Zr, Nb, Mo, Tc, Ru, Rh, Pd, and W, (B) at least one substance selected from the group consisting of organic acids, inorganic acids, and salts of organic acids and inorganic acids, (C) at least one substance selected from the group consisting of Li, Na, K, Be, Co, Mg, Ca, Al, Ni, and Si, and (D) fluorine as an optional component.

Patent Document 2 discloses a liquid composition for forming an anticorrosive film containing (A) an oxidant, (B) a silicate salt and/or silicon dioxide, and (C) at least one metal ion selected from the group consisting of metal cations of one or more elements selected from Ti, Zr, Ce, Sr, V, W, and Mo, anions of oxyacids of the elments, and anions of fluoro acids of the elements.
Patent Document 1: JP2003-171778A
Patent Document 2: JP9-53192A

### DISCLOSURE OF INVENTION

### Object of Invention

However, in the process of forming a chromium-free film proposed in Patent Document 1, an anticorrosive film is formed by coating-type treatment without rinsing after chemical conversion treatment. An anticorrosive film formed from a coating-type chemical conversion treatment solution is referred to below as a coating-type film.

In the process of forming a coating-type film, a liquid layer consisting of a coating-type chemical conversion treatment solution and having a prescribed thickness is formed on a substrate. The medium contained in the liquid layer is vaporized in a drying step so that the liquid layer forms into the shape of a solid film.

Therefore, when the substrate is a fabricated part having a complicated shape, such as a bolt and a nut for a vehicle, it is difficult to obtain a uniform thickness of a liquid layer formed on the surface of the substrate. Since it is difficult to obtain a uniform thickness of a liquid layer, it is also difficult to make the thickness of a coating-type film formed from the liquid layer uniform.

Accordingly, a coating-type film having both a beautiful appearance and sufficient resistance to forming white rust comparable to a film formed by chemical conversion treatment using hexavalent chromate or trivalent chromium has not been obtained. For example, when the substrate is a bolt for a vehicle, the corrosion resistance of the bolt is markedly low at an edge of the bolt such on the threads or the head of the bolt.

All tests for evaluating corrosion resistance performed in Patent Document 1 employ galvanized steel plates as substrates and a fabricated part containing an edge, such as a screw, is not employed in any test.

The fracture strength of a coating-type film such as a film disclosed in Patent Document 1 and/or the shear strength at the interface between the film and the substrate are often lower than the fracture strength of the substrate. Such a film is often fractured or peeled off due to impact with other parts during storage, assembly, and use. The fractured or peeled portion of the part has markedly decreased in corrosion resistance. Therefore, it is often the case that the corrosion resistance of a part having a coating-type film is not evaluated as being high, although the corrosion resistance of the coating-type film has been evaluated as being high. This means that it is difficult to evaluate the reliability of a part having a coating-type film. This difficulty is a serious problem when the part is a bolt or a nut for a vehicle.

When the film disclosed in Patent Document 1 is applied to fabricated members which are not as complicated in shape as a bolt, examples of which include fastening parts such as clamps and clips used in office appliances, electric appliances, and vehicles, press-molded parts such as plates, housings, hinges, and panels, the members may have the following problems.

Since most such parts must be formed with high accuracy, the thickness of an anticorrosive film formed on a substrate (a substrate is defined as an object on which an anticorrosive film is formed and a member is defined as what is obtained by chemical conversion treatment of the substrate in this invention.) is preferably thin.

However, a coating-type film such as a film disclosed in Patent Document 1 has decreased resistance against the formation of white rust, which may be referred to as white rust resistance and which can be evaluated by the length of time until white rust is formed, which time can be measured by equipment for a salt spray test, as the film decreased in the thickness. Therefore, a coating-type film must have a certain thickness.

Thus, a coating-type film inevitably has a substantial variation in thickness, since the coating-type film has a tendency for the variation in thickness to increase while a certain thickness is required for the coated layer. Therefore, the manufacturing tolerance of a substrate must be as small as possible so as to reduce the influence of the variation of the thickness of the coating-type film on the accuracy of the shape of the member formed from the substrate. Namely, when a coating-type film is employed, the processing accuracy in fabricating a substrate must be high. It goes without saying that this requirement reduces the productivity of a member and increases the cost of the member.

Furthermore, preparation of a coating-type film consumes more thermal energy in the step of drying a coated layer so as to form a film in comparison with a film formed from reactive chemical conversion treatment in which a substrate after chemical conversion treatment is washed. Therefore, when preparing a coating-type film, it is necessary to extend the length of time for the drying step, increase the size of drying equipment, and the like, which causes a reduction in productivity and an increase in costs. Although it is possible to increase the temperature in the drying step, there is a risk of deforming a substrate when the substrate is a fabricated part. Therefore, increasing the temperature is disadvantageous because the accuracy required in the fabrication of a substrate must be increased.

Patent Document 2 discloses a solution for reactive chemical conversion treatment. That document discloses that a film having a high degree of white-rust resistance is formed on a steel plate, which is a part formed by primary processing, by applying the solution to the plate. However, it was revealed by the present inventors that the pot life of the chemical conversion treatment solution was very short because precipitates were observed in a solution just after preparation. Furthermore, when a film was formed on a fabricated part by applying the solution, white rust was generated on the film by 24 hours of a salt spray test, and hence the member having the film was considered to have no white-rust resistance.

The object of the present invention is to provide a technique for chromium-free reactive chemical conversion treatment capable of forming an anticorrosive film which has a beautiful appearance and a high degree of white-rust resistance comparable to chemical conversion treatment containing chromium, with high productivity on a substrate having a metallic surface and particularly a fabricated member made of galvanized steel, such as a bolt, a nut, or a press-molded part.

### Means for Resolving the Object of Invention

The above-described object is achieved by performing reactive chemical conversion treatment with the following chromium-free composition for chemical conversion treatment, which may be referred to as a chemical conversion treatment solution.

According to one aspect, the present invention provides a chromium-free acidic liquid composition for reactive chemical conversion treatment for use in forming an anticorrosive film on a metallic surface, the composition comprising at least one oxidative substance selected from a nitric ion and hydrogen peroxide; at least one carboxylic acid compound selected from the group consisting of carboxylic acids, carboxylate ions, carboxylates, and derivatives of carboxylic acids; an aluminum-containing substance; a zirconium-containing substance; and a sulfate ion, wherein the composition does not substantially contain an organic film-forming component.

The aluminum-containing substance is selected from the group consisting of an aluminum ion and water-soluble substances containing an aluminum ion. The zirconium-containing substance is selected from the group consisting of a zirconium ion and water-soluble substances containing a zirconium ion.

The organic film-forming component is a so-called organic binder component. Since the liquid composition according to the present invention is employed for reactive chemical conversion treatment, the composition does not substantially contain the organic film-forming component.

The carboxylic acid compound contained in the above-described composition may comprise at least one polycarboxylic acid compound selected from the group consisting of polycarboxylic acids, polycarboxylate ions, polycarboxylates, and derivatives of polycarboxylic acids.

The carboxylic acid compound contained in the above-described composition may comprise at least one hydroxypolycarboxylic acid compound selected from the group consisting of hydroxypolycarboxylic acids, hydroxypolycarboxylate ions, hydroxypolycarboxylates, and derivatives of hydroxypolycarboxylic acids.

It is preferable that the carboxylic acid compound contained in the above-described composition comprise at least one citric acid compound selected from the group consisting of citric acid, citrate ions, citrates, and derivatives of citric acid, and that the composition contain, on the basis of the total composition, 1.2 to 33.0 g/L of the oxidative compound, 0.6 to 33.0 g/L of the citric acid compound in citric acid content equivalent, 0.25 to 7.0 g/L of the aluminum-containing substance in aluminum equivalent, 0.9 to 23.0 g/L of the zirconium-containing substance in zirconium equivalent, and 0.45 to 40.0 g/L of a sulfate ion.

The above-described composition may further comprise an ion which is a film-forming component with the ion containing one or more elements selected from the group consisting of V, Fe, Cu, Sn, Mo, W, Ce, Co, Ni, Mg, Ca, Mn, and Li.

According to another aspect, the present invention provides a process of producing a member having an anticorrosive film on the surface of a substrate of the member, the substrate having a metallic surface. The process comprises a contacting step comprising contacting the metallic surface of the substrate with a chromium-free acidic liquid composition comprising at least one oxidative substance selected from a nitric ion and hydrogen peroxide; at least one carboxylic acid compound selected from the group consisting of carboxylic acids, carboxylate ions, carboxylates, and derivatives of carboxylic acids; an aluminum-containing substance; a zirconium-containing substance; and a sulfate ion, the composition being substantially free of an organic film-forming component, a washing step comprising washing the substrate after the contacting step, and a drying step comprising drying the substrate after the washing step.

The composition according to the above-described process may further comprise an ion which is a film-forming component, with the ion containing one or more elements selected from the group consisting of V, Fe, Cu, Sn, Mo, W, Ce, Co, Ni, Mg, Ca, Mn, and Li.

According to a further aspect, the present invention provides a member comprising an anticorrosive film formed by the above-described process.

The present invention provides as yet another aspect a chromium-free liquid composition for producing a composition for chemical conversion treatment for use in forming an anticorrosive film on a metallic surface. The composition comprises, on the basis of the total composition: 6.0 to 660 g/l, of at least one oxidative substance selected from a nitric ion and hydrogen peroxide; 3.0 to 660 g/L of at least one citric acid compound in citric acid equivalent, the citric acid compound being selected from the group consisting of citric acid, citrate ions, citrates, and derivatives of citric acid; 1.25 to 140 g/L of an aluminum-containing substance; 4.5 to 460 g/L of a zirconium-containing substance; and 2.25 to 800 g/L of a sulfate ion.

The chemical conversion treatment solution according to the present invention is an acidic solution containing an aluminum ion and a zirconium ion, both in the form of a hydrated ion and/or a coordinated compound. The carboxylic acid compound such as citric acid is contained so as to stabilize the aluminum ion and the zirconium ion. It is thought that the sulfate ion also promotes stabilization of the above-described ions. It is thought that the oxidative substance functions to promote formation of an anticorrosive film by eluting a metal of the surface to be treated such as zinc due to the oxidizing performance of the oxidative substance.

The formed anticorrosive film is a passive film mainly consisting of an oxide and/or a hydroxide of aluminum and zirconium, and has a silvery interference color. The thickness of the film is generally less than 1 micrometer and typically several nm to several hundred nm. Although the anticorrosive film according to the present invention is formed by chromium-free reactive chemical conversion treatment, the film has a high degree of white-rust resistance in a salt spray test, which resistance is comparable to the resistance of a film formed from a chemical conversion treatment solution containing trivalent chromium and/or hexavalent chromium. The anticorrosive film according to the present invention has a beautiful and brilliant appearance, which is comparable to the appearance of a film formed by silvery trivalent chromium chemical conversion treatment, glossy chromate treatment, or yellowish chromate treatment.

Since the anticorrosive film according to the present invention is formed by reactive chemical conversion treatment, when the film is formed on a substrate which is a fabricated part generally having a complicated shape, the formed film has a higher uniformity of thickness than a coating-type film. Therefore, a member having the anticorrosive film according to the present invention makes it possible to increase the productivity of the member compared to a member having a coating-type film. In addition, the hardness of the anticorrosive film according to the present invention is high because the film consists of a passive film of aluminum and zirconium. Therefore, the anticorrosive film is resistant to breakage during collision with other parts, and hence a member having the anticorrosive film according to the present invention has higher reliability compared to a member having a coating-type film.

Furthermore, raw materials for an aluminum-containing substance and a zirconium-containing substance, both of which are main components of the chemical conversion treatment solution, are both inexpensive. Therefore, the chemical conversion treatment can be performed at low cost.

### BRIEF DESCRIPTIONS OF THE DRAWINGS

FIG. 1 is a graph showing the results of the depth analysis of the composition of the anticorrosive film according to Example 3 by XPS.

### BEST MODE FOR CARRYING OUT THE INVENTION

Preferred embodiments of the present invention will be described below.

The reactive chemical conversion treatment solution according to the present invention is a chromium-free acidic liquid composition which comprises at least one oxidative substance selected from a nitric ion and hydrogen peroxide; at least one carboxylic acid compound selected from the group consisting of carboxylic acids, carboxylate ions, carboxylates, and derivatives of carboxylic acids; an aluminum-containing substance; a zirconium-containing substance; and a sulfate ion. In addition, the composition does not substantially contain an organic film-forming component.

The carboxylic acid compound of this chemical conversion treatment solution preferably contains a polycarboxylic acid compound, a hydroxypolycarboxylic acid compound and/or a citric acid compound.

It is preferable that the solution contain, on the basis of the total solution, 1.2 to 33.0 g/L of the oxidative compound, 0.6 to 33.0 g/L of the citric acid compound in citric acid content equivalent, 0.25 to 7.0 g/L of the aluminum-containing substance in aluminum equivalent, 0.9 to 23.0 g/L of the zirconium-containing substance in zirconium equivalent, and 0.45 to 40.0 g/L of a sulfate ion.

When the solution contacts a substrate having a metallic surface, the metal forming the surface of the substrate such as zinc partly elutes and ionizes, and an aluminum ion deposits on the metallic surface as an aluminum hydroxide as a counter-reaction of elution and ionization. A compound containing zirconium based on a zirconium ion also deposits on the metallic surface, and an anticorrosive film is formed. Therefore, the formed anticorrosive film after drying is a film mainly consisting of an oxide and/or a hydroxide of aluminum and zirconium. The anticorrosive film is very dense and has high corrosion resistance comparable to a naturally-passivated oxide film formed on the surface of a member made of aluminum. In particular, the film is superior in an environment of salt spray and is comparable to a hexavalent chromate film when a member having the film is subjected to finishing treatment. Therefore, the present invention can provide an anticorrosive film capable of having corrosion resistance for a long time in coastal regions and cold regions in which salt is spread without using harmful hexavalent chromate.

Since the anticorrosive film according to the present invention is formed by reactive chemical conversion treatment, even when the film is formed on a substrate having a complicated shape, the formed film has higher uniformity of thickness than a conventional coating-type film. Therefore, the appearance of the anticorrosive film is uniform and brilliant, and the dimensional accuracy of a member having the anticorrosive film is so high that the film can be applied to a part which requires a tightly accurate shape.

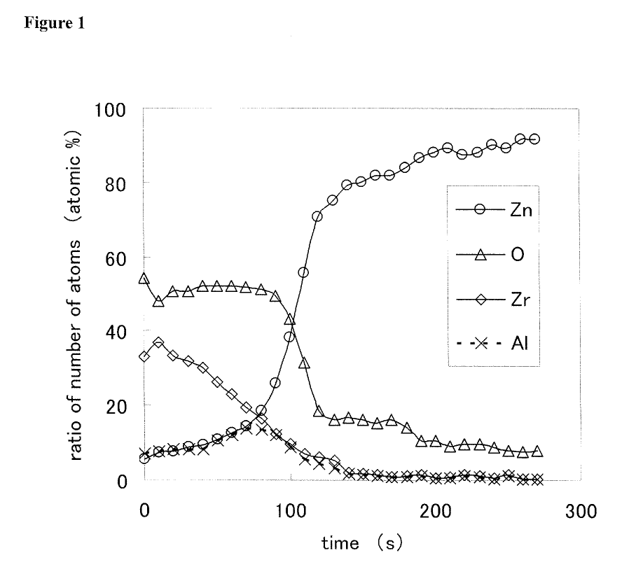

The thickness of the formed film is generally less than 1 micrometer and typically several nm to several hundred nm. The thickness is as thick as that of a film formed by chromate chemical conversion treatment. A depth analysis of the anticorrosive film of Example 3, which will be described below, was performed by XPS (X-ray photoelectron spectroscopy) for confirmation. The sputtering rate of the anticorrosive film in this depth analysis was about 1 nm/s. The results of the analysis are shown in FIG. 1. Since the anticorrosive film according to the present invention is a film formed by reactive chemical conversion treatment, the film has a layer in which the composition gradually changes in the direction of the thickness of the film as shown in FIG. 1. The thickness of the anticorrosive film of Example 3 including the above-described layer is estimated to be about 150 nm.

The result obtained from the X-ray diffraction measurement indicates that this anticorrosive film is amorphous. Although the film consists mainly of an oxide and/or a hydroxide of aluminum and zirconium as described above, the film may contain several % by number of atoms of a metal composing the surface of the substrate on which the film is formed such as zinc. When the chemical conversion treatment solution contains a water-soluble metal-containing substance, which will be described in detail below, the film also contains the water-soluble metal-containing substance itself, a hydroxide of a metal contained in the substance, and/or an oxide of the metal.

As described above, since the anticorrosive film formed from the chemical conversion treatment solution according to the present invention has an excellent appearance and high corrosion resistance, a member comprising the anticorrosive film can be used as is without any further coating. However, it is possible to apply a further coating to the member having the anticorrosive film.

Components of the chemical conversion treatment solution according to the present invention will be explained in detail below.

### 1. Composition of the Chemical Conversion Treatment Solution

### (1) Aluminum-Containing Substance

The chemical conversion treatment solution according to the present invention comprises an aluminum-containing substance. The aluminum-containing substance is selected from the group consisting of an aluminum ion, namely, Al³⁺, and a water-soluble substance containing the ion. Since the chemical conversion treatment solution according to the present invention is acidic, examples of the water-soluble substance containing an aluminum ion solution include Al [H₂O]₆³⁺ and a coordination compound of an aluminum ion and a carboxylic acid compound.

It is preferable to use a water-soluble compound capable of generating an aluminum-containing substance in water, which may be referred to as a water-soluble aluminum compound, as a substance which is provided so that the chemical conversion treatment solution contains an aluminum-containing substance, namely, as a source material of an aluminum-containing substance. Examples of a water-soluble aluminum compound include aluminum chloride, aluminum sulfate, and aluminum nitrate. The water-soluble aluminum compound may consist of one species or of two or more species.

Aluminum is one of the components of the anticorrosive film according to the present invention. Aluminum acts to resist corrosion in the form of an oxide and/or a hydroxide in the film. Therefore, the aluminum-containing substance is a component forming a film, namely, a film-forming component. From the viewpoint of increasing white-rust resistance, it is preferable for the content of the aluminum-containing substance to be large. However, when the content is excessive, there is concern that a precipitate may be formed, depending on other components, or that the functions of other components may be impaired. Therefore, the content of the aluminum-containing substance is preferably 0.01 to 500 g/L and more preferably 0.2 to 190 g/L in aluminum content equivalent. When the content of the aluminum-containing substance is 0.25 to 7.0 g/L in aluminum content equivalent, an anticorrosive film having excellent properties can be stably obtained. Furthermore, from the viewpoint of increasing productivity as well as reducing production costs, the content of the aluminum-containing substance is preferably 0.8 to 3.5 g/L in aluminum content equivalent.

### (2) Zirconium-Containing Substance

The chemical conversion treatment solution according to the present invention comprises a zirconium-containing substance. The zirconium-containing substance is selected from the group consisting of a zirconium ion and a water-soluble substance containing the ion. Examples of the water-soluble substance containing a zirconium ion solution include a coordination compound of a zirconium ion and a carboxylic acid compound.

It is preferable to use a water-soluble compound capable of generating a zirconium-containing substance in water, which may be referred to as a water-soluble zirconium compound, as a source material of a zirconium-containing substance. Examples of a water-soluble zirconium compound include zirconium chloride, zirconium sulfate, and zirconium nitrate. The water-soluble zirconium compound may consist of one species or of two or more species.

Zirconium is one of the components of the anticorrosive film according to the present invention. Zirconium performs the function of resisting corrosion in the form of an oxide and/or a hydroxide in the film. Therefore, the zirconium-containing substance is a film-forming component. From the viewpoint of increasing white-rust resistance, it is preferable for the content of the zirconium-containing substance to be large. However, when the content is excessive, there is concern that a precipitate may be formed, depending on other components, or that the functions of other components may be impaired. Therefore, the content of the zirconium-containing substance is preferably 0.01 to 600 g/L and more preferably 0.8 to 460 g/L in zirconium content equivalent. When the content of the zirconium-containing substance is 0.9 to 23.0 g/L in zirconium content equivalent, an anticorrosive film having excellent properties can be stably obtained. Furthermore, from the viewpoint of increasing productivity as well as reducing production costs, the content of the zirconium-containing substance is preferably 2.5 to 8.0 g/L in zirconium content equivalent.

### (3) Oxidative Substance

The chemical conversion treatment solution according to the present invention comprises at least one oxidative substance. The oxidative substance is selected from a nitric ion and hydrogen peroxide. The function of the oxidative substance is not clear. It is thought that the oxidative substance promotes the formation of an anticorrosive film by dissolving a metal at the surface to be treated, such as zinc, due to its oxidizing nature. There is no limitation on the content of the oxidative substance. When the content is too small, the above-described function cannot be obtained and hence it is difficult to promote the formation of the film. When the content is too large, the roughness of the surface to be treated increases or the chemical conversion treatment solution decreases in stability. Therefore the content of the oxidative substance is preferably 0.1 to 800 g/L and more preferably 1.0 to 635 g/L. When the content of the oxidative substance is 1.2 to 33.0 g/L, an anticorrosive film having excellent properties can be stably obtained. Furthermore, from the viewpoint of increasing productivity as well as reducing production costs, the content of the oxidative substance is preferably 5.0 to 15.0 g/L.

### (4) Sulfate Ion

The chemical conversion treatment solution according to the present invention comprises a sulfate ion. It is thought that the sulfate ion stabilizes the aluminum-containing substance and the zirconium-containing substance. There is no limitation on the content of the sulfate ion. When the content is too small, the above-described function cannot be obtained and hence it is difficult to promote the formation of the film. When the content is too large, the roughness of the surface to be treated increases or the chemical conversion treatment solution decreases in stability. Therefore the content of the sulfate ion is preferably 0.01 to 1000 g/L and more preferably 0.30 to 790 g/L. When the content of the sulfate ion is 0.45 to 40.0 g/L, an anticorrosive film having excellent properties can be stably obtained. Furthermore, from the viewpoint of increasing productivity as well as reducing production costs, the content of the sulfate ion is preferably 7.0 to 12.0 g/L.

### (5) Carboxylic Acid Compound

The chemical conversion treatment solution according to the present invention comprises a carboxylic acid compound. The carboxylic acid compound is selected from the group consisting of carboxylic acids having a carboxyl group (—COOH), carboxylate ions formed by reducing a proton from a carboxyl group of the carboxylic acid, carboxylates containing the carboxylate ions, and compounds capable of forming a carboxylic acid and/or a carboxylate ion by hydrolysis and the like, namely, derivatives of carboxylic acids. Examples of derivatives of carboxylic acids include esters, acid anhydrides, amides, acid halides, and nitriles, and coordination compounds containing a carboxylic acid, a carboxylate ion, and/or the above-described derivatives of carboxylic acids.

Examples of carboxylic acids include a monocarboxylic acid such as formic acid, acetic acid, and propionic acid; a dicarboxylic acid such as oxalic acid, malonic acid, succinic acid, glutaric acid, adipic acid, pimelic acid, suberic acid, azelaic acid, sebacic acid, maleic acid, phthalic acid, and terephthalic acid; a tricarboxylic acid such as tricarballylic acid; a hydroxycarboxyl acid such as glycolic acid, lactic acid, malic acid, tartaric acid, citric acid, and ascorbic acid; and an aminocarboxylic acid such as glycine, alanine, and ethylenediaminetetraacetic acid (EDTA). Examples of preferable carboxylic acid compounds include a polycarboxylic acid compound, a hydroxypolycarboxylic acid, and a citric acid compound.

A polycarboxylic acid compound is selected from the group consisting of polycarboxylic acids, polycarboxylate ions, polycarboxylates, and derivatives of polycarboxylic acids. Examples of the polycarboxylic acid compound include oxalic acid and tricarballylic acid.

A hydroxypolycarboxylic acid compound is selected from the group consisting of hydroxypolycarboxylic acids, hydroxypolycarboxylate ions, hydroxypolycarboxylates, and derivatives of hydroxypolycarboxylic acids. Examples of the hydroxypolycarboxylic acid compound include malic acid and tartaric acid.

A citric acid compound is selected from the group consisting of citric acid, citrate ions, citrates, and derivatives of citric acid.

The carboxylic acid compound may consist of one species or of two or more species.

It is thought that the carboxylic acid compound becomes a component of an aluminum-containing substance and a zirconium-containing substance, and promotes stabilization of an aluminum ion and a zirconium ion in the chemical conversion treatment solution. Therefore, the preferable content of the carboxylic acid compound depends on the content of the aluminum-containing substance and the content of the zirconium-containing substance. The content of the carboxylic acid compound is typically 0.01 to 800 g/L and preferably 0.5 to 650 g/L. When the content of the carboxylic acid compound is 0.6 to 33.0 g/L, an anticorrosive film having excellent properties can be stably obtained. Furthermore, from the viewpoint of increasing productivity as well as reducing production costs, the content of the carboxylic acid compound is preferably 5.0 to 10.0 g/L.

### (6) Other Components

The chemical conversion treatment solution according to the present invention may comprise a water-soluble metal-containing substance.

A water-soluble metal-containing substance is a substance containing one or more elements selected from the group consisting of V, Fe, Cu, Sn, Mo, W, Ce, Co, Ni, Mg, Ca, Mn, and Li. In particular, the substance is selected from positive ions of the above-described elements and a water-soluble substance containing including at least one of these ions. Examples of the water-soluble substance include ions of oxygen acids such as a vanadate ion, a molybdate ion, and a tungstate ion, and coordination compounds containing ions of the above-described elements. Mo and V are preferable elements from the viewpoints of improving the stability of the chemical conversion treatment solution, the brilliant appearance of the formed film, and the corrosion resistance of the formed film.

The chemical conversion treatment solution may contain elements other than the above-described elements. However, when the solution contains Si and/or Ti, these elements form polymers by crosslinking these elements with each other via a hydroxide ion and the like. Because of the polymers, the chemical conversion treatment solution may decrease in stability, and hence the pot life of the solution may be shortened. Therefore, the chemical conversion treatment solution according to the present invention is preferably free from Si and/or Ti.

When the water-soluble metal-containing substance is contained in the chemical conversion treatment solution, the species and the content of the substance depend on the required properties of the anticorrosive film, the production cost, and the like. Therefore, the preferable range of the content of the water-soluble metal-containing substance cannot be specified definitively. The molar content of the water-soluble metal-containing substance is typically as much as the sum of the molar content of the aluminum-containing substance in aluminum molar content equivalent and the molar content of the zirconium-containing substance in zirconium molar content equivalent.

Since the chemical conversion treatment solution according to the present invention is free from chromium, a substance containing chromium is not added in preparing the solution. However, it is acceptable for the chemical conversion treatment solution according to the present invention to incidentally contain a minute amount of a substance containing chromium.

The chemical conversion treatment solution according to the present invention may further contain an amine.

Examples of the amine include monoamines such as triethylamine (TEA), N,N′-dimethylcyclohexylamine (DMEDA); diamines such as ethylenediamine (EDA), 1,2-propanediamine, 1,6-hexamethylenediamine, piperazine, 2,5-dimethylpiperazine, isophoronediamine, 4,4′-dicyclohexyldiamine, 3,3′-dimethyl-4,4′-dicyclohexylmetanediamine, 1,4-cyclohexanediamine, N,N,N′,N′-tetramethylethylenediamine (TMEDA), N,N,N′,N′-tetramethylhexane-1,6-diamine (TMHMDA); polyamines such as diethylenetriamine, dipropylenetriamine, triethylenetetamine, tetraethylenepentamine, tetrapropylenepentamine, pentaethylenehecamine, nonaethylnedecamine, triethylehexamethylenediamine, tetra(aminomethyl)methane, tetrakis(2-aminoethylaminomethyl)methane, 1,3-bis(2′-ammethylamino)propane, triethylene-bis(trimethylene)hexamine, bis(3-aminoethyl)amine, bishexamethylenetriamine, 1,4-cyclohexanediamine, 4,4′-methylenebiscyclohexylamine, 4,4′-isopropylidenebiscyclohexylamine, norbornadiamine, bis(aminomethyl)cyclohexane, diaminodicyclohexylmethane, isophoronediamine, menthenediamine, N,N,N′,N′,N″-pentamethyldipropylenetriamine (PMDPTA), tetramethylguanidine (TMG); cyclic amines such as triethylenediamine (TEDA), N,N′-dimethylepiperazine, N-methylmorpholine (NMMO); and alcohol amines such as hydroxyethylhydrazine, hydroxyethyldiethylenetriamine, 2-[(2-hydroxyethyl)amino]ethanol, 3-aminopropanedioldimethylaminoethanol (DMEA), N-methyl-N′-(2-hydroxyethyl)-piperazine (MHEP).

It is thought that the amine becomes a component of an aluminum-containing substance, a zirconium-containing substance, and/or a water-soluble metal-containing substance, and stabilizes an aluminum ion, a zirconium ion, and/or ions of the above-described elements in the chemical conversion treatment solution. Preferable ions are diamines such as EDA.

Since the amine is added so as to increase the stability of the chemical conversion treatment solution, the preferable content of the amine depends on the species and the contents of other components of the solution such as the aluminum-containing substance, and the function of the amine. Therefore, the preferable range of the content of the amine cannot be specified definitively. The amine content is typically 0.1 to several g/L.

The chemical conversion treatment solution according to the present invention may contain an organic inhibitor.

Any compound known as an organic inhibitor can be used as the organic inhibitor. Examples of the organic inhibitor include heterocyclic organic compounds containing nitrogen and/or sulfur, and thiocarbonyl compounds. Examples of heterocyclic organic compounds include 1,10-phenanthroline, 2,2′-bipyridyl, diphenylthocarbazone, pyrol-2-carboxyaldehyde, benzotriazole, 8-quinolinol, 2-mercaptobenzothiazole, and benzimidazole. Examples of thiocarbonyl compounds include thiourea, dimethylthiocarbaminic acid, ethylenethiourea, phenylthiourea, dibutylthiourea, sulfide demethylxanthate, and tetramethylthiuram monosulfide.

There is no limitation on the content of the organic inhibitor. The content of the organic inhibitor may be at most 2 g/L and normally at most 1 g/L.

An effect of improving corrosion resistance is expected due to the addition of the inhibitor.

The chemical conversion treatment solution according to the present invention may further contain a counter-anion of a component containing metal. From the viewpoint of ensuring the stability of the chemical conversion treatment solution, the counter-anion is preferably selected from substances other than a phosphate ion.

In addition, a surfactant, an anti-forming agent, and the like may be added to the chemical conversion treatment solution according to the present invention, as long as the properties of the anticorrosive film are not spoiled by these added substances.

The chemical conversion treatment solution does not contain an organic film-forming component. An organic film-forming component is a so-called organic binder component and consists of a monomer and/or a polymer which are soluble or dispersible in a medium. When a chemical conversion treatment solution containing an organic film-forming component is coated on a substrate so that a liquid layer consisting of the chemical conversion treatment solution is formed on the substrate and the coating step is followed by a drying step comprising drying the substrate having the liquid layer without rinsing the substrate after the coating step, a medium contained in the layer is volatized and hence the organic film-forming component becomes a component of an anticorrosive film. Therefore, the organic film-forming component is mainly contained in a coating-type chemical conversion treatment solution.

In contrast, since a substrate which has been contacted with a reactive chemical conversion treatment solution for a prescribed time is washed, an organic film-forming component contained in the reactive chemical conversion treatment solution has been rinsed away by the washing step before forming a film. Therefore, even when an organic film-forming component is contained in a reactive chemical conversion treatment solution, it is substantially impossible for the component in the solution to become a component of a film formed from the solution. Accordingly, the chemical conversion treatment solution according to the present invention does not substantially contain an organic film-forming component because the solution is a reactive chemical conversion treatment solution.

### (7) Solvent, pH

A solvent of the chemical conversion treatment solution according to the present invention consists mainly of water. From the viewpoint of improving the solubility of components such as amines in the chemical conversion treatment solution, the solvent may contain an organic solvent which is soluble in water, such as alcohols, ethers, and esters. There is no limitation on the ratio of the amount of the organic solvent to the total amount of the solvent. From the viewpoint of easy effluent treatment, the ratio is preferably at most 10% by weight.

Since the chemical conversion treatment solution according to the present invention is acidic, the pH of the solution is less than 7.0. The pH is preferably at most 6.0 from the viewpoint of stabilizing the chemical conversion treatment solution. From the viewpoints of increasing productivity as well as reducing production costs, the pH is preferably 1.0 to 5.0 and more preferably 1.2 to 4.0. The pH of a chemical conversion treatment solution may be adjusted by using a solution containing having an arbitrary content of known alkalis or acids. Preferable acids are sulfuric acid and nitric acid which are included in the above-described essential components, and preferable alkalis are sodium hydroxide, potassium hydroxide, and ammonia.

### 2. Process of Producing Anticorrosive Film

The steps for producing a member having the anticorrosive film according to the present invention are as follows, in which steps enclosed in parentheses are arbitrary steps.

(activation step->washing step)->chemical conversion treatment step->washing step->(finishing step)->drying step

The order of these steps is similar to the order of steps for reactive chromate chemical conversion treatment. Although the solutions used in the chemical conversion treatment of the present invention and reactive chromate chemical conversion treatment are different, operations performed in the chemical conversion treatment step are similar to operations performed in the reactive chromate chemical conversion treatment. Therefore, the process according to the present invention can be performed with equipment for conventional chromate chemical conversion treatment. Although the activation step (and the subsequent washing step) and the finishing step can be omitted, it is preferable that both steps be performed, because the activation step is effective for forming a uniform anticorrosive film, and the finishing step is effective for improving the corrosion resistance of the film.

Each step will be explained below.

### (1) Activation Step

The activation step may be performed by using any solution for activating the metallic surface of a substrate. In general, the treatment is performed by contacting the substrate with an acidic solution. The contacting is preferably performed with an aqueous solution containing a strong inorganic acid such as nitric acid, hydrochloric acid, or sulfuric acid. The most preferable acid is nitric acid.

When the metallic surface consists of a zinc-containing plating, an acidic aqueous solution for the activation step, which will be referred to as a solution for activation, preferably contains an ion of a metal nobler than zinc and a chelating agent for surface adjustment. Because of these components, the surface of the zinc-containing plating is activated, namely, a surface oxide layer inhibiting the reaction of chemical conversion treatment is removed by the acid. In addition, a conversion plating in which zinc is dissolved and instead the metal nobler than zinc is deposited on a part of the substrate where there is a tendency for an excessive chemical conversion reaction to occur, such as an edge of the substrate. Since this deposited metal inhibits further dissolution of zinc, surface adjustment, namely, leveling is obtained. Therefore, the subsequent chemical conversion treatment can uniformly occur all over the surface of the substrate, even when the substrate has a complicated shape.

Preferable examples of the ion of a metal nobler than zinc include ions of metals such as Fe, In, Co, Ni, Mo, Sn, Cu, Pd, and Ag. It is preferable not to use Pb, Cr, and Cd, since these metals are known to be hazardous. There is no limitation on the source materials of the ions of metals. The source material may be salts of organic or inorganic acids. The source material may be hydroxides or oxides as long as they are soluble in the solution for activation. The source material may be metals as long as they are soluble in the solution for activation.

The chelating agent coordinates to the above-described metals and inhibits excess generation of the conversion plating of the metal ions, so that the conversion plating occurs only on especially active parts. Any conventional chelating agent can be used as the chelating agent. A preferred chelating compound is an organic compound containing nitrogen or sulfur. Examples of such a compound inlude polyamines such as EDTA and derivatives of EDTA, and compounds containing a thiol group such as thioglycolic acid and mercaptosuccinic acid. Such chelating agents can also function as organic inhibitors.

A surfactant can be contained in the solution for activation in order to clean the metallic surface of the substrate. There is no limitation on the type of surfactant. The surfactant may be a nonion-type, a cation-type, or an anion-type.

The activation step is performed by contacting the substrate with a solution for activation for a prescribed length of time. Examples of specific methods for contacting include immersion, spraying, and roll-coating. There is no limitation on treatment conditions such as the temperature of the solution and the length of time for which contact is performed, as long as the object of the treatment is achieved. The conditions depend on the solution for activation. The temperature of the solution is typically room temperature to 80 degrees C., and 20 to 50 degrees C. is preferable. The length of time for which contact is performed depends on the temperature of the solution and will generally be in the range of 5 to 300 seconds. The step of washing the substrate after contact with the solution for activation may be performed by conventional methods, such as immersion and spraying.

### (2) Chemical Conversion Treatment Step

The chemical conversion treatment step is preferably performed directly after the washing step following the activation step without drying the washed substrate. A substrate which has been dried after the washing step can be provided to the chemical conversion treatment step without any additional procedure, as long as the length of time that has elapsed since the substrate dried is not long.

The chemical conversion treatment step is performed by contacting a chemical conversion treatment solution with a metallic surface of the substrate. There is no limitation on specific methods of performing the contact. The substrate having a metallic surface may be immersed into a bath of the chemical conversion treatment solution according to the present invention, the chemical conversion treatment solution may be sprayed on the substrate, or a roll impregnated with the chemical conversion treatment may contact the substrate.

The conditions for the chemical conversion treatment step such as the temperature of treatment and the length of time for which treatment is performed will be specified based on consideration of the composition of the chemical conversion treatment solution, so that an anticorrosive film having a sufficient thickness enough to meet the requirements of the treatment is obtained. The temperature of the chemical conversion treatment solution is typically 10 to 80 degrees C. and preferably 20 to 50 degrees C. The length of time for which contact is performed depends on the temperature of the solution and will generally be in the range of 5 to 300 seconds. Based on the following facts, the length of time for which contact is performed is preferably at most 1 minute so as to increase productivity.

(i) The anticorrosive film according to the present invention has high white-rust resistance even when the thickness of the film is thin.

(ii) In the chemical conversion treatment according to the present invention, a material formed of a component of the chemical conversion treatment solution deposits on the surface of a substance by substitution of a metal forming the surface of the substrate, and hence the thickness of the formed anticorrosive film reaches a limit even when the length of time for which contact is performed is excessive.

### (3) Washing Step

The substrate after being contacted by the above-described chemical conversion treatment solution may be washed by conventional means. As described above, in the process of producing an anticorrosive film according to the present invention, a chemical conversion treatment solution which was not directly involved with forming an anticorrosive film and which remains on the surface of the member is removed by washing the substrate. Therefore, the thickness of an anticorrosive film according to the present invention obtained by drying the member after washing is generally several nm to several hundred nm, which is much thinner than the thickness of an anticorrosive film obtained by coating-type chemical conversion treatment of the prior art. Since the thickness of the anticorrosive film is thin, the variation of the thickness of the film is small. Furthermore, even when members both having the anticorrosive film collide with each other, the films are not readily broken.

### (4) Finishing Step

As described above, the anticorrosive film according to the present invention formed on the surface of a substrate has high corrosion resistance. However, another coating treatment may be performed on the member to form a top layer. A finishing step in which another coating treatment is performed is preferably performed just after the washing step which is followed by the chemical conversion treatment step. However, the finishing step may be performed after an anticorrosive film formed by the chemical conversion treatment step is dried.

There is no limitation on the specific type of treatment performed in the finishing treatment. Examples of a finishing agent include a solution main component of which is a film-forming silicone compound. Examples of the film-forming silicone compound include alkylsilicates, namely, tetraalkoxysilanes such as ethylsilicate, alkali metal silicates such as lithium silicate, potassium silicate, and sodium silicate, colloidal silica such as silica sol, and silane coupling agents.

The white-rust resistance of the film is improved due to the finishing step. The total anticorrosive film after the finishing step can be so thin that its total thickness is at most a few micrometers. Therefore, the finishing step can be applied to small and/or precise parts such as a micro bolt having micro threads.

### (5) Drying Step

The member after the above-described chemical conversion treatment step or the member on which the finishing agent is coated when the finishing step is followed by the chemical conversion treatment step is then dried. When the finishing step is performed, another drying step may be performed between the washing step after the chemical conversion treatment step and the finishing step.

Due to the drying step, hydroxides in the anticorrosive film formed by the chemical conversion treatment step are partly or completely converted to oxides, namely, aluminum oxide and zirconium oxide. When the finishing agent is applied, there is a chemical change in the top layer such that metal compounds such as hydrolyzable silane compounds are completely hydrolyzed to form metal hydroxides and the formed hydroxides are converted to metal oxides by a dehydration reaction.

There is no limitation on the conditions of the drying step. The drying conditions can be milder than the drying condition used in the process of producing a conventional coating-type anticorrosive film, because the thickness of the formed anticorrosive film is thinner than the thickness of the coating-type anticorrosive film. The highest temperature of the member in the drying step is typically 10 to 150 degrees C. and preferably 40 to 120 degrees C., and the length of time for drying is about 1 to 15 minutes depending on the drying temperature. Since the drying conditions are relatively mild, the equipment for the drying step according to the present invention is smaller than the equipment for the drying step of the process of producing a conventional coating-type anticorrosive film, and the energy consumption of the drying step according to the present invention is relatively small. In addition, since changes in the dimensions of the member caused by the drying step, namely, thermal deformation of the member does not readily occur, the processing accuracy in the fabrication of a substrate of the member can be reduced compared to coating-type chemical conversion treatment, even when the member is required to be formed with high accuracy of is high. Therefore, the possibility of producing defective members in the drying step is relatively small, and hence higher productivity compared to coating-type chemical conversion treatment can be achieved.

### 3. Substrate

There is no limitation on a substrate to which the chemical conversion treatment according to the present invention can be applied, as long as the substrate has a metallic surface. The material of the substrate is preferably a metal, and especially preferably a steel having a zinc-containing plating. The zinc-containing plating may consist only of zinc, or it may consist of a zinc alloy. Examples of the zinc alloy include a zinc-iron alloy, a zinc-nickel alloy, and a zinc-aluminum alloy. The zinc alloy may be one having a less than 50% by weight, such as a Zn-55% Al alloy. There is no limitation on the thickness of the zinc-containing plating. When a member having a zinc-containing plating is required to be formed with high accuracy, the thickness is preferably 3 to 15 micrometers. The specific methods for producing the zinc-containing plating may be electroplating, hot-dip plating, or hot-dip plating followed by alloying.

There is no limitation on the shape of the substrate. An anticorrosive film having excellent properties can be formed from the chemical conversion treatment according to the present invention even on a fabricated part having complicated shapes. Specific examples of the substrate include small parts such as bolts, nuts, rivets, and washers, fabricated parts such as press-molded parts, machined parts, and forged parts. The present invention may be applied to parts formed by primary processing, such as wire rods and thin plates.

### 4. Liquid Composition for Preparing the Chemical Conversion Treatment Solution

It is preferable to prepare an aqueous liquid composition which is 5 to 20 times as concentrated as the above-described chemical conversion treatment solution. The concentrated solution, which may be referred to below as a dense solution for chemical conversion treatment, is advantageous because a dense solution does not require weighing each component separately and is easy to store.

When the dense solution for chemical conversion treatment is prepared, the upper limit on the content of the dense solution is determined in view of the solubility of each component in the dense solution. Specifically, a composition comprising, on the basis of the total composition, 6.0 to 660 g/L of at least one oxidative substance selected from a nitric ion and hydrogen peroxide; 3.0 to 660 g/L of at least one citric acid compound in citric acid equivalent, the citric acid compound being selected from the group consisting of citric acid, citrate ions, citrates, and derivatives of citric acid; 1.25 to 140 g/L of an aluminum-containing substance; 4.5 to 460 g/L of a zirconium-containing substance; and 2.25 to 800 g/L of a sulfate ion, can easily provide the above-mentioned chemical conversion treatment solution which contains, on the basis of the total composition, 1.2 to 33.0 g/L of the oxidative compound, 0.6 to 33.0 g/L of the citric acid compound in citric acid content equivalent, 0.25 to 7.0 g/L of the aluminum-containing substance in aluminum equivalent, 0.9 to 23.0 g/L of the zirconium-containing substance in zirconium equivalent, and 0.45 to 40.0 g/L of a sulfate ion by a proper preparation procedure.

### EXAMPLES

Although the present invention will be concretely described below with respect to examples, the invention should not be considered as being in any way limited to these examples.

### 1. Preparation of Galvanized Members

Substrates in the form of galvanized members were prepared by forming one of the following zinc-containing platings by electroplating on M10 bolts having a total length of 100 mm and a length of the threaded part of 50 mm, and on nuts corresponding to the bolts. Both the bolts and the nuts are made of SPCC. Each electroplating for preparing the galvanized members was performed with conventional barrel plating.

### (1) Zinc Plating

A zinc electroplating layer having a thickness of 8 micrometers was formed from a solution for acidic zinc plating. Electroplating was performed according to the process specified for METASU MZ-11, which is a product of Yuken Industry Co., Ltd.

### (2) Zinc-Iron Alloy Plating

A zinc-iron alloy plating layer having a thickness of 8 micrometers was formed from a solution for zincate zinc-iron alloy plating. The solution was prepared so that the eutectoid ratio of iron in the formed plating layer was 0.4%. Electroplating was performed according to the process specified for METASU AZ, which is a product of Yuken Industry Co., Ltd.

### (3) Zinc-Nickel Alloy Plating

A zinc-nickel alloy electroplating layer having a thickness of 8 micrometers was formed from a solution for zinc-nickel alloy plating. The solution was prepared so that the eutectoid ratio of nickel in the formed plating layer was 15%. Electroplating was performed according to the process specified for METASU ANT-28, which is a product of Yuken Industry Co., Ltd.

### Comparative Examples 1 to 4

Comparative Examples 1 to 4 were prepared to illustrate chemical conversion treatment using conventional chromium-free chemical conversion treatment solutions. It is noted that a washing step after chemical conversion treatment was performed in all comparative examples so as to clarify the difference between the effect of the present invention and the effects of comparative examples.

1 kg of the galvanized members on which one of the above-described zinc-containing plating layers was performed were placed into a metallic basket having a resin coating on the surface, and the members were subjected to chemical conversion treatment in which an activation step, a first washing step, a chemical conversion treatment step, a second washing step, and a drying step were sequentially performed. Details of the steps are as follows.

### [Activation Step]

A dilute nitric acid solution at room temperature containing 1% (10 ml/L) of a 62.5% nitric acid solution was prepared. The activation step was performed by immersing and shaking the basket containing the galvanized members in the solution for 10 seconds.

### [First Washing Step]

After the activation step, the galvanized members were washed by immersing and shaking the basket containing the galvanized members in water at room temperature for 10 seconds.

### [Chemical Conversion Treatment Step]

The chemical conversion treatment step was performed by immersing and shaking the basket containing the galvanized members in one of the chemical conversion treatment solutions shown in Table 1, namely, chemical conversion treatment solutions 1 to 4, under the conditions shown in Table 2.

The content of each component containing metal in the compositions of the chemical conversion treatment solutions shown in Table 1 is indicated by the content in metal content equivalent.

### [Second Washing Step]

The washing step after the chemical conversion treatment step was performed in the same manner as the first washing step.

### [Drying Step]

The basket containing galvanized members after the second washing step was set in a centrifuge and the basket was centrifuged for 10 minutes at 60 degrees C. to obtain members having a conventional anticorrosive film.

TABLE 1

| | Comparative Examples | | | | Examples | | | | | | | | |
|---|---|---|---|---|---|---|---|---|---|---|---|---|---|
| solution No. | 1 | 2 | 3 | 4 | 5 | 6 | 7 | 8 | 9 | 10 | 11 | 12 | 13 |
| Al content (g/L) | — | — | — | — | 0.81 | 1.35 | 1.35 | 6.75 | 0.81 | 0.54 | 0.81 | 0.27 | 2.43 |
| aqueous Al | | | | | aluminum | | aluminum nitrate | | | | | aluminum | |
| compound | | | | | sulfate | | | | | | | chloride | |
| Zr content (g/L) | — | — | — | 0.0004 | 6.39 | 4.56 | 4.56 | 22.81 | 3.65 | 4.56 | 3.65 | 8.21 | 0.91 |
| aqueous Zr | | | | zirconium | zirconium nitrate | | | | | | | | |
| compound | | | | oxychloride | | | | | | | | | |
| Ti content (g/L) | 1.4 | — | 1.4 | 0.02 | — | — | — | — | — | — | — | — | — |
| source material | titanium | | titanium | titanium | | | | | | | | | |
| of Ti | sulfate | | sulfate | chloride | | | | | | | | | |
| Mo content (g/L) | — | 0.01 | — | — | — | — | — | — | — | — | — | — | — |
| source material | | ammnonium | | | | | | | | | | | |
| of Mo | | molybdate | | | | | | | | | | | |
| V content (g/L) | 2.7 | — | — | — | — | — | — | — | 1.53 | 1.53 | — | — | — |
| source material of V | sodium | | | | | | | | sodium | | | | |
| | vanadate | | | | | | | | metavanadate | | | | |
| Mn content (g/L) | — | — | 0.05 | — | — | — | — | — | — | — | 1.65 | — | — |
| source material | | | manganese | | | | | | | | manganese | | |
| of Mn | | | chloride | | | | | | | | nitrate | | |
| Mg content (g/L) | — | — | 0.01 | — | — | — | — | — | — | — | — | — | — |
| source material | | | magnesium | | | | | | | | | | |
| of Mg | | | nitrate | | | | | | | | | | |
| sodium silicate (g/L) | | 10 | | 20 | — | — | — | — | — | — | — | — | — |
| phosphoric acid | 10 | 10 | 10 | — | — | — | — | — | — | — | — | — | — |
| (g/L) | | | | | | | | | | | | | |
| nitrate ion (g/L) | 5 | — | 5 | — | 6.20 | 6.20 | 6.20 | 31.01 | 4.34 | 13.64 | 4.34 | 6.20 | 6.20 |
| sulfate ion (g/L) | — | — | — | — | 10.93 | 7.81 | 7.81 | 38.43 | 6.25 | 7.81 | 6.25 | 14.05 | 1.56 |
| glycine (g/L) | — | — | — | 10 | — | — | — | — | — | — | — | — | — |
| hydrogen peroxide | — | — | — | 40 | — | — | — | — | — | — | — | — | — |
| (g/L) | | | | | | | | | | | | | |
| citric acid (g/L) | — | — | — | — | 6.30 | 10.51 | 6.30 | 31.52 | 6.30 | 2.10 | 6.30 | 6.30 | 21.01 |
| maronic acid (g/L) | — | — | — | — | — | — | — | — | — | — | — | 1.04 | — |
| EDA (g/L) | — | — | — | — | 0.60 | — | — | — | — | — | — | — | — |
| EDTA (g/L) | — | — | — | — | — | 3.72 | — | — | — | — | — | — | — |

TABLE 2

| | | | |
|---|---|---|---|
| Comparative | Comparative | Comparative | Comparative |
| Example 1 | Example 2 | Example 3 | Example 4 |

| | |
|---|---|
| plating material | zinc |

| | | | | |
|---|---|---|---|---|
| solution No. | 1 | 2 | 3 | 4 |
| temperature | 40° C. | 40° C. | 40° C. | 45° C. |
| pH | 2.3 | 2.0 | 2.0 | 4.5 |
| time (s) | 60 | 60 | 30 | 60 |

| | Example 1 | Example 2 | Example 3 | Example 4 | Example 5 | Example 6 | Example 7 | Example 8 | Example 9 |
|---|---|---|---|---|---|---|---|---|---|
| plating material | | zinc | | | | | | | |
| solution No. | 5 | 6 | 7 | 8 | 9 | 10 | 11 | 12 | 13 |
| temperature | 40° C. | 40° C. | 40° C. | 40° C. | 40° C. | 40° C. | 40° C. | 40° C. | 40° C. |
| pH | 1.8 | 2 | 2.3 | 2 | 2.5 | 2 | 2 | 2 | 2 |
| time (s) | 60 | 60 | 60 | 60 | 60 | 60 | 60 | 60 | 60 |
| | Example | Example | Example | | | | | | |
| | 10 | 11 | 12 | Example 13 | Example 14 | Example 15 | Example 16 | Example 17 | Example 18 |
| plating material | zinc-iron alloy | | | | | | | | |
| solution No. | 5 | 6 | 7 | 8 | 9 | 10 | 11 | 12 | 13 |
| temperature | 40° C. | 40° C. | 40° C. | 40° C. | 40° C. | 40° C. | 40° C. | 40° C. | 40° C. |
| pH | 1.8 | 2 | 2.3 | 2 | 2.5 | 2 | 2 | 2 | 2 |
| time (s) | 60 | 60 | 60 | 60 | 60 | 60 | 60 | 60 | 60 |
| | Example | Example | Example | | | | | | |
| | 19 | 20 | 21 | Example 22 | Example 23 | Example 24 | Example 25 | Example 26 | Example 27 |
| plating material | zinc-nickel alloy | | | | | | | | |
| solution No. | 5 | 6 | 7 | 8 | 9 | 10 | 11 | 12 | 13 |
| temperature | 40° C. | 40° C. | 40° C. | 40° C. | 40° C. | 40° C. | 40° C. | 40° C. | 40° C. |
| pH | 1.3 | 1.5 | 1.8 | 1.5 | 2 | 1.5 | 1.5 | 1.5 | 1.5 |
| time (s) | 60 | 60 | 60 | 60 | 60 | 60 | 60 | 60 | 60 |

### Examples 1 to 39

1 kg of the galvanized members on which one of the zinc-containing plating layers shown in Tables 2 and 4 was performed were placed into a metallic basket having a resin coating on its surface, and the members were subjected to chemical conversion treatment in which an activation step, a first washing step, a chemical conversion treatment step, a second washing step, and a drying step were subsequently performed. Details of the steps are as follows.

### [Activation Step]

A dilute nitric acid solution at room temperature containing 1% (10 ml/L) of a 62.5% nitric acid solution was prepared. The activation step was performed by immersing and shaking the basket containing the galvanized members in the solution for 10 seconds.

### [First Washing Step]

After the activation step, the galvanized members were washed by immersing and shaking the basket containing the galvanized members in water at room temperature for 10 seconds.

### [Chemical Conversion Treatment Step]

The chemical conversion treatment step was performed by immersing and shaking the basket containing the galvanized members in one of the chemical conversion treatment solutions shown in Tables 1 and 3, namely, chemical conversion treatment solutions 5 to 17, under the conditions shown in Table 2 or 4.

The content of each component containing metal in the compositions of the chemical conversion treatment solutions shown in Tables 1 and 3 is indicated by the content in metal content equivalent.

### [Second Washing Step]

The washing step after the chemical conversion treatment step was performed in the same manner as the first washing step.

### [Drying Step]

The basket containing galvanized members after the second washing step was set in a centrifuge, and the basket was centrifuged for 10 minutes at 60 degrees C. to obtain members having a conventional anticorrosive film.

TABLE 3

| | Examples | | | |
|---|---|---|---|---|
| solution No. | 14 | 15 | 16 | 17 |
| Al content (g/L) | 2.00 | 3.00 | 2.00 | 2.00 |
| aqueous Al compound | aluminum nitrate | | | |
| Zr content (g/L) | 4.10 | 6.15 | 4.10 | 4.10 |
| aqueous Zr compound | zirconium nitrate | | | |
| Ti content (g/L) | — | — | — | — |
| source material of Ti | — | — | — | — |
| Mo content (g/L) | — | — | — | 1.92 |
| source material of Mo | — | — | — | sodium |
| | | | | vanadate |
| V content (g/L) | — | — | 0.26 | — |
| source material of V | — | — | sodium | — |
| | | | metavanadate | |
| Mn content (g/L) | — | — | — | — |
| source material of Mn | — | — | — | — |
| Mg content (g/L) | — | — | — | — |
| source material of Mg | — | — | — | — |
| sodium silicate (g/L) | — | — | — | — |
| phosphoric acid (g/L) | — | — | — | — |
| nitrate ion (g/L) | 11.60 | 17.4 | 11.60 | 11.60 |
| sulfate ion (g/L) | 11.00 | 16.5 | 11.00 | 11.00 |
| glycine (g/L) | — | — | — | — |
| hydrogen peroxide (g/L) | — | — | — | — |
| citric acid (g/L) | 6.30 | 9.45 | 6.30 | 6.30 |
| maronic acid (g/L) | — | — | — | — |
| EDA (g/L) | — | — | — | — |
| EDTA (g/L) | — | — | — | — |

TABLE 4

| | Example 28 | Example 29 | Example 30 | Example 31 |
|---|---|---|---|---|
| plating material | zinc | | | |
| solution No. | 14 | 15 | 16 | 17 |
| temperature | 40° C. | 40° C. | 40° C. | 40° C. |
| pH | 1.8 | 2 | 2.3 | 2 |
| time (s) | 60 | 60 | 60 | 60 |
| | Example 32 | Example 33 | Example 34 | Example 35 |
| plating material | zinc-iron alloy | | | |
| solution No. | 14 | 15 | 16 | 17 |
| temperature | 40° C. | 40° C. | 40° C. | 40° C. |
| pH | 1.8 | 2 | 2.3 | 2 |
| time (s) | 60 | 60 | 60 | 60 |
| | Example 36 | Example 37 | Example 38 | Example 39 |
| plating material | zinc-nickel alloy | | | |
| solution No. | 14 | 15 | 16 | 17 |
| temperature | 40° C. | 40° C. | 40° C. | 40° C. |
| pH | 1.3 | 1.5 | 1.8 | 1.5 |
| time (s) | 60 | 60 | 60 | 60 |

### 2. Means for Evaluation

Galvanized members after treatment were evaluated from the viewpoints of the appearance of the anticorrosive film, the stability of the chemical conversion treatment solution, and the corrosion resistance of the anticorrosive film

### (1) Appearance

The brightness and color of the members after treatment were evaluated with the naked eye.

### (2) Corrosion Resistance

The members (bolts and nuts) having various anticorrosive films were subjected to a salt spray test based on the test defined by JIS Z2371. Measurement was performed by observing each member with the naked eye every 24 hours to check whether white rust had developed on the surface of the member. When white rust was observed on a member, the total length of the salt spray test was used as an index of corrosion resistance of the tested member.

### (3) Stability of Solution

i) Chemical conversion treatment solutions just after preparation were observed from the viewpoints of the formation of precipitates and decreases in clearness. The evaluation criterion was as follows:

A: The solution was clear and no precipitate was observed.

B: The solution was turbid but no precipitate was observed.

C: Precipitates were observed in the solution.

ii) The prepared solutions were sealed and stored for 1 week at 40 degrees C. The solutions after the storage were observed from the viewpoints of the formation of precipitates and decreases in clearness. The evaluation criterion was as follows:

A: The solution was clear and no precipitate was observed.

B: The solution was turbid but no precipitate was observed.

C: Precipitates were observed in the solution.

D Precipitates generated just after preparation were developed.

### 3. Evaluation Result

The results of the above-described evaluations are shown in Tables 5 and 6.

TABLE 5

| | | | appearance of | |
|---|---|---|---|---|
| | | time at | solution | |
| | appearance of | which white | | after |
| | anticorrosive film | rust formed (h) | initial | storage |
| Comparative | dull | 96 | C | D |
| Example 1 | | | | |
| Comparative | greenish | 48 | A | B |
| Example 2 | | | | |
| Comparative | brownish | 96 | C | D |
| Example 3 | | | | |
| Comparative | dull | 24 | C | D |
| Example 4 | | | | |
| Example 1 | gloss | 144 | A | A |
| Example 2 | gloss | 144 | A | A |
| Example 3 | gloss | 240 | A | A |
| Example 4 | gloss | 240 | A | A |
| Example 5 | gloss | 168 | A | A |
| Example 6 | gloss | 168 | A | A |
| Example 7 | gloss | 168 | A | A |
| Example 8 | slightly less uniform | 144 | A | A |
| Example 9 | gloss | 168 | A | A |
| Example 10 | gloss | 504 | A | A |
| Example 11 | gloss | 504 | A | A |
| Example 12 | gloss | 600 | A | A |
| Example 13 | gloss | 600 | A | A |
| Example 14 | gloss | 528 | A | A |
| Example 15 | gloss | 528 | A | A |
| Example 16 | gloss | 528 | A | A |
| Example 17 | slightly less uniform | 504 | A | A |
| Example 18 | gloss | 528 | A | A |
| Example 19 | gloss | 720 | A | A |
| Example 20 | gloss | 720 | A | A |
| Example 21 | gloss | 816 | A | A |
| Example 22 | gloss | 816 | A | A |
| Example 23 | gloss | 744 | A | A |
| Example 24 | gloss | 744 | A | A |
| Example 25 | gloss | 744 | A | A |
| Example 26 | gloss | 720 | A | A |
| Example 27 | gloss | 744 | A | A |

TABLE 6

| | | time at | | |
|---|---|---|---|---|
| | appearance of | which white | appearance of solution | |
| | anticorrosive film | rust formed (h) | initial | after storage |
| Example 28 | gloss | 168 | A | A |
| Example 29 | gloss | 240 | A | A |
| Example 30 | gloss | 240 | A | A |
| Example 31 | gloss | 168 | A | A |
| Example 32 | gloss | 504 | A | A |
| Example 33 | gloss | 600 | A | A |
| Example 34 | gloss | 528 | A | A |
| Example 35 | gloss | 528 | A | A |
| Example 36 | gloss | 744 | A | A |
| Example 37 | gloss | 816 | A | A |
| Example 38 | gloss | 816 | A | A |
| Example 39 | gloss | 744 | A | A |

An anticorrosive film having a brilliant color cannot be uniformly formed on small parts having complicated shapes by any conventional chemical conversion treatment solution shown in Comparative Examples 1 to 4, in spite of performing the second washing step after the chemical conversion treatment step. Specifically, the appearance was dull, greenish, or brownish. The anticorrosive films did not have high corrosion resistance, since the length of time until white rust formed was at most 96. The chemical conversion treatment solutions did not have high stability, since no solution could maintains high clarity after storage for one week.

On the contrary, an anticorrosive film having a brilliant color comparable to the film formed by chromate chemical conversion treatment was uniformly formed from each chemical conversion treatment solution according to the present invention, as shown by Examples 1 to 39. As for corrosion resistance, the anticorrosive films of the Examples had high corrosion resistance comparable to the films formed by chromate chemical conversion treatment. Each of the chemical conversion treatment solutions of the Examples had such high stability that each solution was not turbid and no precipitate was formed after storage for one week. Although the anticorrosive films obtained in Examples 8 and 17 were both brilliant, the films were slightly less uniform in brightness than other films obtained in other Examples.

1. A chromium-free acidic liquid composition for reactive chemical conversion treatment for use in forming an anticorrosive film on a metallic surface, the composition comprising:
at least one oxidative substance selected from a nitric ion and hydrogen peroxide;
at least one carboxylic acid compound selected from the group consisting of carboxylic acids, carboxylate ions, carboxylates, and derivatives of carboxylic acids;
an aluminum-containing substance;
a zirconium-containing substance; and
a sulfate ion,
wherein the composition does not substantially contain an organic film-forming component.

2. The composition according to claim 1, wherein the carboxylic acid compound comprises at least one polycarboxylic acid compound selected from the group consisting of polycarboxylic acids, polycarboxylate ions, polycarboxylates, and derivatives of polycarboxylic acids.

3. The composition according to claim 1, wherein the carboxylic acid compound comprises at least one hydroxypolycarboxylic acid compound selected from the group consisting of hydroxypolycarboxylic acids, hydroxypolycarboxylate ions, hydroxypolycarboxylates, and derivatives of hydroxypolycarboxylic acids.

4. The composition according to claim 1, wherein the carboxylic acid compound comprises at least one citric acid compound selected from the group consisting of citric acid, citrate ions, citrates, and derivatives of citric acid, and the composition contains, on the basis of the total composition, 1.2 to 33.0 g/L of the oxidative compound, 0.6 to 33.0 g/L of the citric acid compound in citric acid content equivalent, 0.25 to 7.0 g/L of the aluminum-containing substance in aluminum equivalent, 0.9 to 23.0 g/L of the zirconium-containing substance in zirconium equivalent, and 0.45 to 40.0 g/L of a sulfate ion.

5. The composition according to claim 1, wherein the composition further comprises a water-soluble metal-containing substance as a film-forming component, and the water-soluble metal-containing substance contains one or more elements selected from the group consisting of V, Fe, Cu, Sn, Mo, W, Ce, Co, Ni, Mg, Ca, Mn, and Li.

6. A process of producing a member having an anticorrosive film on the surface of a substrate of the member, the substrate having a metallic surface, the process comprising:
a contacting step comprising contacting the metallic surface of the substrate with a chromium-free acidic liquid composition comprising at least one oxidative substance selected from a nitric ion and hydrogen peroxide; at least one carboxylic acid compound selected from the group consisting of carboxylic acids, carboxylate ions, carboxylates, and derivatives of carboxylic acids; an aluminum-containing substance; a zirconium-containing substance; and a sulfate ion, the composition being substantially free of an organic film-forming component,
a washing step comprising washing the substrate after the contacting step, and
a drying step comprising drying the substrate after the washing step.

7. The process according to claim 6, wherein the composition further comprises a water-soluble metal-containing substance as a film-forming component, and the water-soluble metal-containing substance contains one or more elements selected from the group consisting of V, Fe, Cu, Sn, Mo, W, Ce, Co, Ni, Mg, Ca, Mn, and Li.

8. The process according to claim 6, wherein the substrate is a fabricated metallic part.

9. A member comprising an anticorrosive film formed by the process described in claim 6.

10. A chromium-free liquid composition for producing a composition for chemical conversion treatment for use in forming an anticorrosive film on a metallic surface, the composition comprising, on the basis of the total composition:
6.0 to 660 g/L of at least one oxidative substance selected from a nitric ion and hydrogen peroxide;
3.0 to 660 g/L of at least one citric acid compound in citric acid equivalent, the citric acid compound being selected from the group consisting of citric acid, citrate ions, citrates, and derivatives of citric acid;
1.25 to 140 g/L of an aluminum-containing substance;
4.5 to 660 g/L of a zirconium-containing substance; and
2.25 to 800 g/L of a sulfate ion.
